(19) United States
(12) Patent Application Publication
(10) Pub. No.: US 2024/0015347 A1
(43) Pub. Date: Jan. 11, 2024

(54) METHODS AND SYSTEMS FOR SCHEDULING THE DISPLAY OF INTERACTIVE CONTENT

(71) Applicant: Rovi Guides, Inc., San Jose, CA (US)

(72) Inventors: Vishwas Sharadanagar Panchaksharaiah, Tiptur (IN); Vikram Makam Gupta, Bangalore (IN); Gyanveer Singh, Bihar (IN)

(21) Appl. No.: 17/857,892

(22) Filed: Jul. 5, 2022

(51) Int. Cl. H04N 21/262; H04N 21/472

(52) U.S. Cl. CPC H04N 21/26241; H04N 21/47205

(57) ABSTRACT

A content provision system is disclosed. The advent of potential interactivity in advertisements and other content items means that the time for which those advertisements absorb the attention of the user cannot be known in advance. This presents a challenge when the interactive advertisements or other content items are to be accommodated in a scheduled slot for such items. To address this challenge, the duration of interaction of each interactive content item is estimated, statistically measured or modelled in advance of the scheduled slot, and at least one of the interactive items is provided in the slot at a time which accords with the duration of interaction. Where there are a plurality of interactive content items for inclusion in the slot, the interactive contents items can be ordered such that those having a longer duration of interaction are provided closer to the start of the slot.

### BACKGROUND

The present invention relates to methods and systems for scheduling the display of one or more interactive content items for accommodation in a timeslot in other media content. It has particular utility where the interactive content items comprise interactive advertisements.

### SUMMARY

Content provision technology is increasingly allowing content providers to incorporate interactivity in their content. Examples include content hosting platforms which allow creators of video content to include links to web-pages or other files displayed over, or alongside, the video content.

During the display of live, catch-up or streaming content, advertisement breaks are often shown. It is envisaged that these advertisement breaks will in the future comprise one or more interactive elements which a user can interact with. The interactiveness of the advertisement may, for example, provide the user with more information about a product or service.

One problem with interactive advertisements is that the user may leave the application through which the media content is being played. A user then may then be distracted and forget to return or resume watching the media content that was being played by the application.

This is particularly problematic for the display of live media content (such as sports, and news), or scheduled television broadcasts, as the provision of the media content will continue whether the user returns to watch it or not. As such, a user may miss the resumption of the media content after the advertisement break has ended. Conversely, fear of doing so may prompt a user to interact with adverts less as they do not wish to potentially miss the media content. This leads to an inefficient use of the resources of the content provision system. There is thus a need to control content provision in a manner which accommodates the insertion of interactive content in a timeslot in live or scheduled content.

In accordance with some aspects of the disclosure, there is provided a method of scheduling the display of one or more interactive content items for accommodation in a timeslot in other media content, the method comprising: obtaining an estimated interaction duration for each of the one or more interactive content items; and determining a display time in the timeslot for at least one of the interactive content items based on the estimated interaction duration for the at least one interactive content item.

By obtaining the estimated interaction durations of different interactive content items, determining a display time (in a timeslot in other media content) for at least one of the interactive content items based on the estimated interaction duration for the interactive content item, a method of scheduling the display of one or more interactive content items is provided which improves the efficiency of the utilization of the resources of the content provision system whilst accommodating both interactive and live or scheduled content.

In some example methods, the method further comprises displaying the at least one interactive content item on a display device in accordance with the determined display time.

In some example methods, the one or more interactive content items comprise a plurality of interactive content items.

In some example methods, determining the display time for at least one of the interactive content items comprises determining which of a first and second interactive content item to be displayed in the timeslot has a longer estimated interaction duration, and assigning an earlier display time to whichever of the first and second interactive content item is determined to have a longer estimated interaction duration.

In some example methods, the interactive content items comprise interactive advertisements.

In some example methods, the method further comprises selecting a plurality of interactive advertisements for display during the timeslot.

In some example methods, obtaining estimated interaction durations for each of the one or more interactive content items comprises obtaining one or more attributes of the interactive content items, and determining the estimated interaction duration for the interactive content item based on the one or more attributes.

In some example methods, the one or more attributes comprise an attribute indicative of whether the interaction requires the launching of an application on the user device. In a subset of those example methods, the attribute might be indicative of which application is launched.

In some example methods, obtaining estimated interaction durations for the interactive content items comprises using historical interaction data for the interactive content items.

In some example methods, obtaining estimated interaction durations for the interactive content items comprises using historical interaction data for interactive content items having one or more attributes in common with the interactive content item.

In some example methods, obtaining estimated interaction durations for an interactive content item comprises using historical data of a plurality of users that have interacted with the interactive content item.

In some example methods, each interactive content item includes interaction duration metadata and obtaining estimated interaction durations for the interactive content items comprises reading the interaction duration metadata.

In accordance with some aspects of the disclosure, there is provided content provision apparatus comprising a content scheduler arranged in operation to schedule the display of one or more interactive content items to be accommodated in a timeslot in other media content by obtaining an estimated interaction duration for each of the one or more interactive content items, and determining a display time in the timeslot for at least one of the interactive content items based on the estimated interaction duration for the at least one interactive content item.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and shall not be considered limiting of the breadth, scope, or applicability of these concepts. It should be noted that for clarity and ease of illustration these drawings are not necessarily made to scale.

The above and other objects and advantages of the disclosure may be apparent upon consideration of the following detailed description, given by way of example only, and taken in conjunction with the accompanying drawings, in which:

FIG. 1 shows an example content provision system, in accordance with some embodiments of the disclosure.

FIG. 2 shows an example data structure recording interaction durations for interactive advertisements, in accordance with some embodiments of the disclosure.

FIG. 3 shows an example method of scheduling advertisements in a timeslot in other content, in accordance with some embodiments of the disclosure.

FIG. 4 shows an example method of ordering advertisements based on their respective interactive durations, in accordance with some embodiments of the disclosure.

FIG. 5 shows an example data structure recording measured durations of interactions of users with an interactive advertisement, in accordance with some embodiments of the disclosure.

FIG. 6 shows an example method of generating statistics of interaction time for an interactive advertisement, in accordance with some embodiments of the disclosure.

FIG. 7A shows an example data structure recording the interactivity type of different advertisements, in accordance with some embodiments of the disclosure.

FIG. 7B shows an example data structure recording an average duration of interactions with adverts of each of various interactivity types, in accordance with some embodiments of the disclosure.

FIG. 8 shows an example method of determining an estimated interaction time for an interactive advertisement based on attributes of the advertisement, in accordance with some embodiments of the disclosure.

FIG. 9 shows an example data structure recording measured durations of interactions of users with interactive advertisements which have different values of various attributes, in accordance with some embodiments of the disclosure.

FIG. 10 shows an example method of generating an attribute-based model of interaction time for an interactive advertisement, in accordance with some embodiments of the disclosure.

FIG. 11 shows an example method of determining an estimated interaction time for an interactive advertisement, in accordance with some embodiments of the disclosure.

FIG. 12 shows an example of how different interactive advertisements might be ordered in an advertisement break, in accordance with some embodiments of the disclosure.

### DETAILED DESCRIPTION

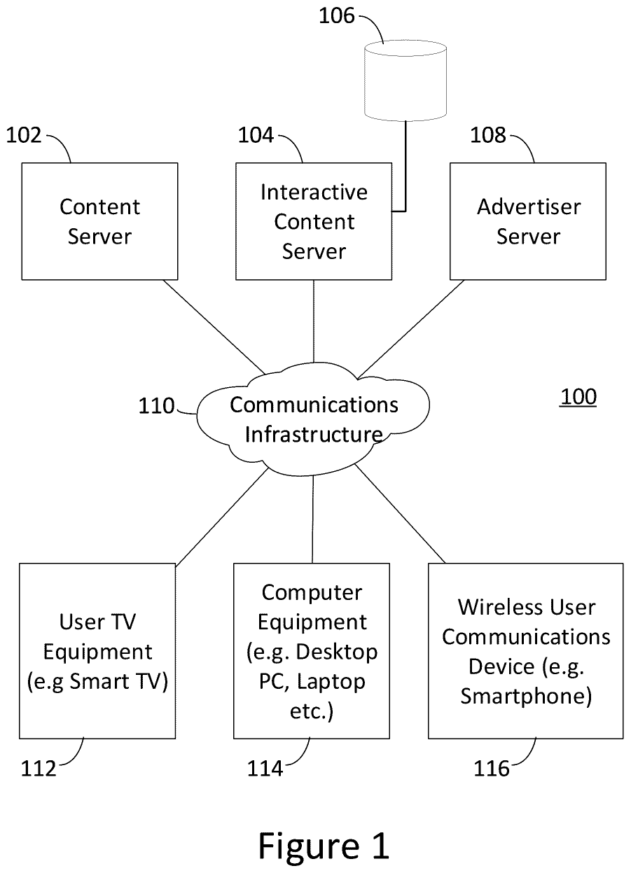

FIG. 1 illustrates a content provision system 100 which comprises one or more content sources (102, 104, 108) connected to one or more content consumption devices (112, 114, 116) via communications infrastructure 110.

The communications infrastructure may comprise one or more terrestrial, satellite or cable broadcast networks, and/or switched or routed networks (for example the Internet).

In the present example, the one or more content sources include one or more content servers 102, one or more interactive content servers 104, and one or more advertiser servers 108.

One content server 102 is arranged in operation to provide scheduled or live content to one or more of the content consumption devices (112, 114, 116). The scheduled or live content includes breaks into which other content can be inserted. Another content server 102 may be arranged to stream content over the Internet to one or more of the content consumption devices (112, 114, 116).

An interactive content server 104 is arranged in operation to provide interactive advertisements with which the content viewer may interact using a user interface provided by the content consumption device (112, 114, 116) on which they are viewing the content. The content may, for example, be streamed over the Internet. In many cases, the interaction between the user and the content sources will involve downloading content from an advertiser server 108 to the content consumption device (112, 114, 116). The content may be downloaded in response to the user selecting a hyperlink included in the interactive content which points to a resource on the advertiser server 108. The interactive content server 104 may have access to a persistent storage device 106.

In the present example, the one or more content consumption devices (112, 114, 116) include one or more instances of television equipment 112, one or more computers 114, and one or more wireless communications devices 116. In each case, the content consumption device (112, 114, 116) includes a display screen for displaying content to the user, and input peripherals (e.g. a remote control, keyboard, mouse, touchscreen, or microphone) to enable the user to provide input to the content consumption device (112, 114, 116). In some cases, spoken input from the user might be intermediated by an intelligent digital assistant (e.g. to provide a natural language interface between the user and the content consumption device). In other cases, the content consumption device (112, 114, 116) might be provided with a built-in natural language capture facility and a built-in natural language understanding facility. In a hybrid case, the content consumption device (112, 114, 116) might have a built-in natural language capture facility which interacts via communications infrastructure 110 to a cloud-based natural language understanding facility which takes speech received from the user and translates that speech to machine-readable commands which are returned to control the content consumption device (112, 114, 116) in accordance with the words spoken by the user.

Each of the content consumption devices (112, 114, 116) may include a persistent store for storing programs or other content (for example, interactive advertisements) for later consumption.

The user TV equipment 112 may include a TV tuner for converting television signals broadcast on a given channel to pictures for display on the display screen. It also may include a receiver for receiving encoded television signals over a bi-directional communications network such as the Internet. The user TV equipment 112 may, for example, be connected to the Internet and arranged to receive streaming services transmitted over the Internet from one or more of the content sources (102, 104, 106).

The computer equipment 114 may, for example, comprise a desktop PC, or a laptop PC.

The wireless user communications device may, for example, comprise a tablet or a smartphone connected to a content source via a cellular network or via a wireless local area network (each then forming part of the communications infrastructure 110).

Each of the computer equipment 114 and the wireless user communications device 116 may, for example, be connected to the Internet and arranged to receive streaming services transmitted over the Internet from one or more of the content sources (102, 104, 106).

Content servers 102 may include a broadcast content source which broadcasts or multicasts programs on one or more channels in accordance with a schedule. Each of the content consumption devices (112, 114, 116) may then include an electronic program guide facility or application which receives directly or indirectly the schedule for each channel. By interacting with an electronic program guide displayed on the screen of the device, the user is able to select a scheduled program which they wish to view or record for later consumption.

Broadcast television often includes advertisement breaks. These typically have a duration of a few minutes and feature around ten advertisements of, say, 15, 30 or 60 second duration. Conventionally, the advertisements are included in the broadcast signal and feature advertisements tailored to archetypal viewers of the program into which the advertisements are inserted.

Content servers 102 may include a video-on-demand servers which offer users a catalog of programs which they can choose to stream to their content consumption device (112, 114, 116). An electronic program guide facility or application on the content consumption device (112, 114, 116) may generate a display setting out programs available in the catalog of a streaming service, and often a catalog of catalogs from respective providers of on-demand content.

Because advertisements accompanying video-on-demand content are not broadcast or multicasts to a large number of viewers, advertisements in on-demand content can be personalized. So-called ‘in-stream’ advertisements can be pre-roll advertisements shown before the content, mid-roll advertisements shown during the content or post-roll advertisements shown after the content. The selection of which advertisements to include in what is displayed on the screen of the content consumption device can be made on the server-side (e.g. by the content provider in accordance with a user profile built and maintained by the content provider), or on the client-side (e.g. by the provider of the electronic program guide (EPG) application using a user profile built and maintained by the EPG application provider). In hybrid cases, a pool of advertisements might be made available by the content provider, and a selection from the pool of advertisements for display before, during or after the video-on-demand content might be made by the EPG application provider.

Some video-on-demand content sources allow users to upload content in order to make that content available to other viewers.

Some content sources enable content providers (from multinational enterprises to individual users) to generate interactive advertisements with which users can interact using the input peripherals associated with their content consumption device. In contrast to conventional video advertising, the effective duration of such advertisements is not known in advance, in part because it depends upon the speed with which the user perceives the possibility of inputting information, and then in fact inputs information, and the time taken by the user to assimilate any information provided in response. In addition, the speed with which the content provision system responds can depend upon a number of factors (e.g. one or more of: the number of steps in the interaction, the duration of each step, the input peripheral available to and used by the user, the amount of information presented to user, the reading speed of the user, whether the interaction involves the launching of another application on the content consumption device, and the delay between the content consumption device and the interactive content source 104 and/or the advertiser server 108).

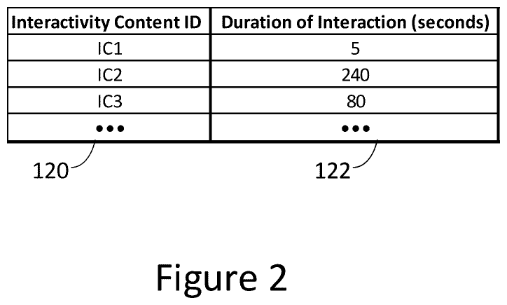

The content provision system may store a data structure (FIG. 2) which records for each of a number of interactive advertisements (identified by advertisement ID 120) an estimated interactive duration 122 (for example, the expected duration of the interaction if the user were to choose to interact with the advertisement). The estimated duration 122 of each advertisement might for example be provided as metadata transmitted along with the advertisement by the interactive content source 104. In such case, the advert duration data structure (FIG. 2) might be stored in a file or database stored in persistent storage device 106.

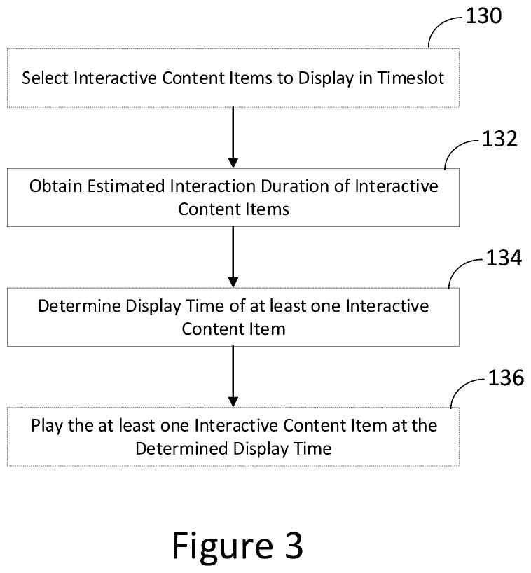

The content provision system 100 may perform an advertisement scheduling process (FIG. 3) which uses the estimated interaction duration information to determine the display time of the advertisement.

Optionally, the advertisement scheduling process begins with a selection 130 of one or more advertisements to be displayed in a timeslot (in a particular example, to be displayed in a scheduled advertisement break included in live or scheduled content from content source 102). Thereafter, the content provision system 100 obtains the estimated interaction duration of one or more of the (optionally previously selected) interactive advertisements, and determines 134 the display time in the timeslot of the interactive advertisement. Having determined 134 the display time, the interactive advert is then played 136 at the determined display time.

In some examples, the steps of the advertisement scheduling process are performed by the content consumption device (112, 114, 116). In other examples, the selection of interactive advertisements and the determination of the display time might be performed by the interactive content server 104 (for example, based on an interaction duration read from the persistent store 106). In such cases, the interactive content server 104 can provide a stream which places the selected advertisement at a determined temporal location in the stream.

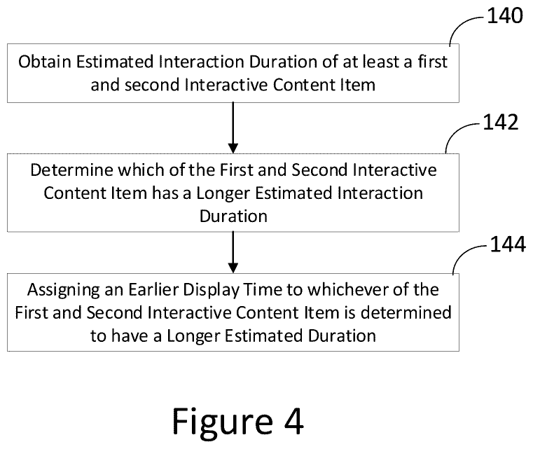

When the content provision system 100 selects a plurality of interactive advertisements for inclusion in the same advertisement break, an advertisement ordering process (FIG. 4) is performed by the content provision system 100. The process starts by obtaining 140 the estimated interaction duration of at least a first and second interactive content item, then determines 142 which of the first and second interactive content items has a longer estimated interaction duration, and then assigns 144 an earlier display time to whichever of the first and second interactive advertisements is determined to have a longer estimated duration.

In some cases the steps of the advertisement ordering process (FIG. 4) might be performed by the interactive content server 104. In other cases, the steps might be performed by the content consumption device (112, 114, 116). The latter might, for example, involve the interactive advert durations being provided as metadata transmitted along with the advertisement, so that the content consumption device (112, 114, 116) is able to obtain the estimated interaction duration by reading the metadata transmitted along with the advert. The advert and accompanying metadata might be sent in advance of the advertisement break for recording on the persistent store of the content consumption device for later selection and ordering by the content consumption device (112, 114, 116).

In some cases, the content provision system 100 may generate the advert duration data by measuring the interactive duration of advertisements provided by the system.

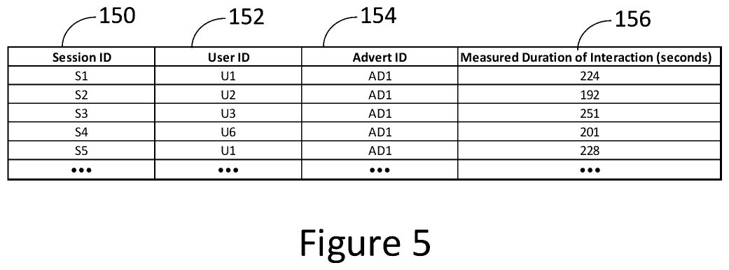

FIG. 5 shows a data structure which records, for a given advert, a measured interaction duration for each of a number of sessions in which a user interacts with the advert. Such advert duration data might be stored in persistent store 106, for example.

The measured interactive advert duration data structure comprises a record for each session, the record comprising a session ID 150, a user ID 152, an interactive advert ID 154, and measured duration of interaction 156.

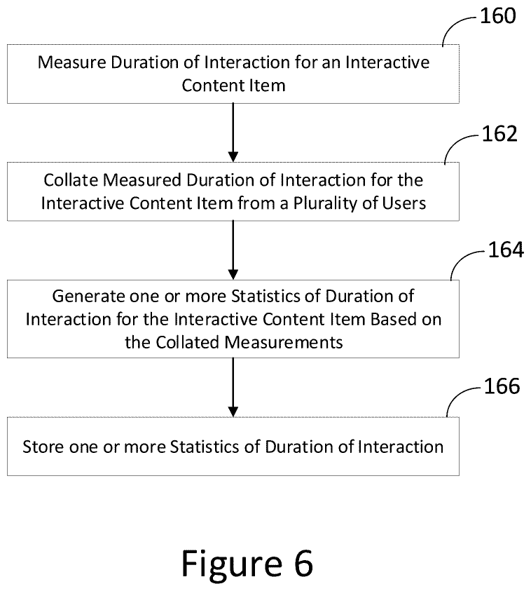

FIG. 6 illustrates a process for generating advert duration data (e.g. the data structure seen in FIG. 2) from measured advert duration data (e.g. as seen in FIG. 5).

The interactive advert duration data generation process begins with measuring 160 the duration of the interaction for an interactive advertisement. The measurement may, for example, be performed by the content consumption device (112, 114, 116) which might subtract the time at which it started to display the interactive advertisement from the time it started playing content to follow the interactive advertisement. The measurements from different user interactive sessions with the interactive advertisement may then be collated 162. In cases where the content consumption device (112, 114, 116) measures the interaction duration, each content consumption device (112, 114, 116) might report that measurement to the interactive content server 104. The collated data may then be processed 164 to generate statistics of the interaction duration for an interactive advertisement or group of interactive advertisements. Statistical measures might include a measure of central tendency such as an average (e.g. arithmetic mean, median or mode), or a maximum duration or a predetermined percentile of a distribution of interactive durations. The statistical measures thus generated may then be stored 166 (e.g. in a data structure like that seen in FIG. 2).

In some examples, rather than generating a data structure which associates durations with individual interactive advertisements, a data structure might be used which associates durations with groups of advertisements, in particular different types of advertisements.

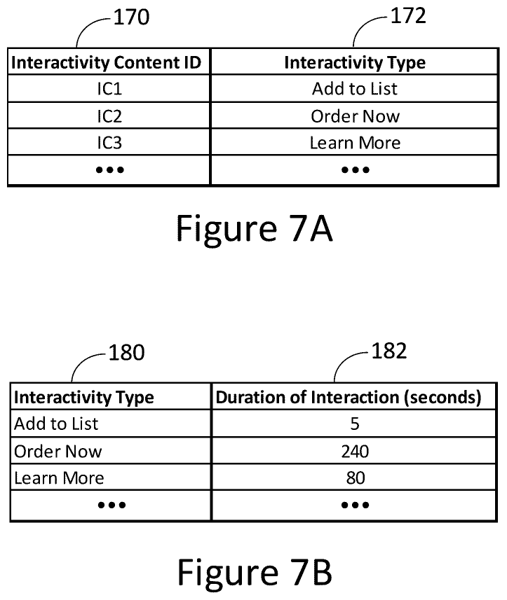

FIG. 7A shows a data structure which associates different types of interactivity with different advertisements. In the data structure, each advertisement ID 170 is associated with a particular activity type 172.

FIG. 7B shows an advert type duration data structure similar to FIG. 2 but which associates a particular activity type 180 with an interaction duration 182. The data structure may, for example, be stored in persistent storage 106 associated with interactive content server 104.

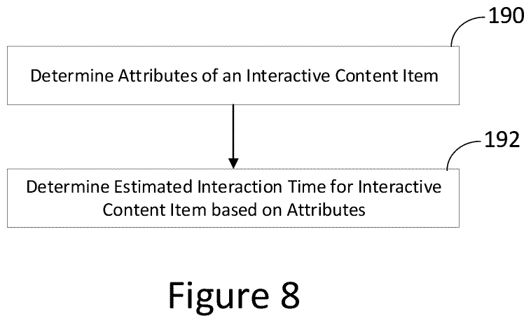

FIG. 8 shows how the advert type duration data structure (FIG. 7B) might be used to determine an estimated interaction time for a given interactive advertisement. In a first step, one or more attributes (e.g. the type of the advertisement) is determined 190. This might be done by looking up an advertisement ID provided with the advertisement in a data structure like FIG. 7A, or the advertisement type might be found from metadata provided with the advertisement, or might be deduced from automatic analysis of the content of the advertisement. Thereafter, an estimated interaction time for the interactive advertisement is determined 192 based on the attributes determined in the previous step. This determination might, for example, be made using the advert type duration data structure seen in FIG. 7B.

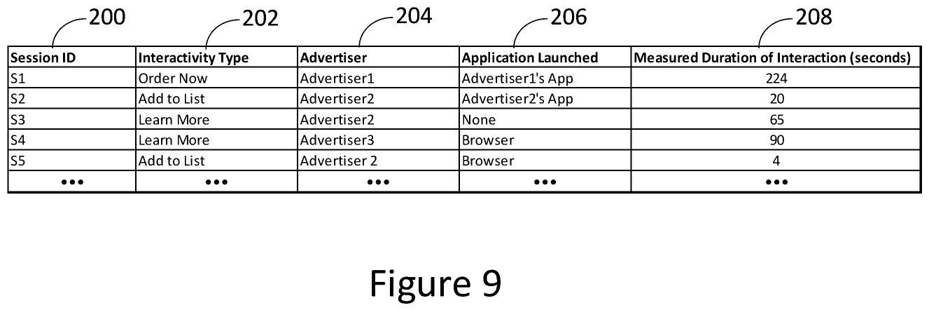

Even more sophisticated attribute-based data might be generated and used in the content provision system 100. For example, the attribute-based advert duration data structure of FIG. 9 might be generated and stored.

The attribute-based advert duration data structure (FIG. 9) comprises a plurality of records, each of which includes a session ID 200, values of one or more attributes 202, 204, 206 and a measured interaction duration 208 for the session. In this case the attributes comprise an advert interactivity type 202, an advertiser ID 204, an application launched as part of the interaction 206, but any one or subset of those attributes might be used instead. Other advert attributes might be used instead of, or in addition to those attributes.

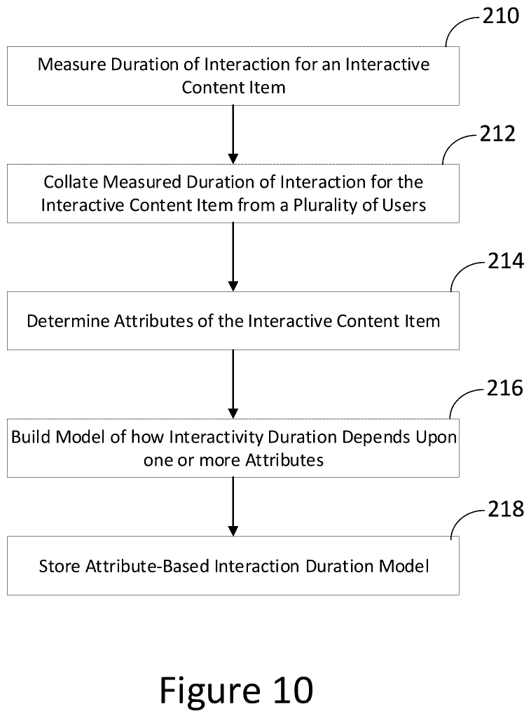

FIG. 10 illustrates a process for generating a machine-learnt model which can provide an estimated interaction duration of an interactive advertisement given values of selected attributes of an interactive advertisement. The first two steps of the process involve measuring 210 interactive durations and collating 212 the measured durations. These steps (210, 212) correspond to the measuring and collating steps of FIG. 6. Before, during or after the durations are measured 210 and collated 212, the attributes of the interactive advertisement are determined 214. The process thus creates a data structure like that seen in FIG. 9. Having created such a data structure, that data can be used to train various machine learning systems to build a model which can provide an estimated duration (or estimated range of durations) given values of the attributes used to train the model. A variety of machine-learnt models could be generated—examples include a decision tree, a neural network or a nearest neighbor model. The model may be updated from time-to-time when new training data becomes available.

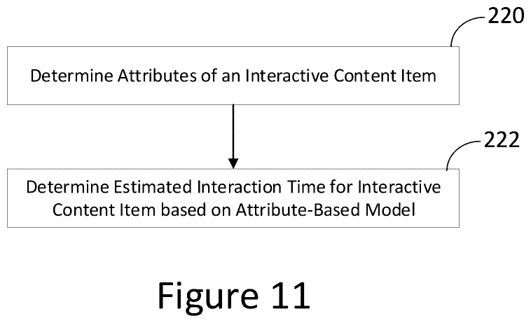

FIG. 11 illustrates how a machine-learnt model might be used to determine an estimated interaction duration of an interactive advertisement. Firstly, the value of the attributes used in the model is determined 220 for the interactive advertisement. Thereafter, by inputting those values into the machine-learnt model, the estimated duration for the interactive advertisement is found 222.

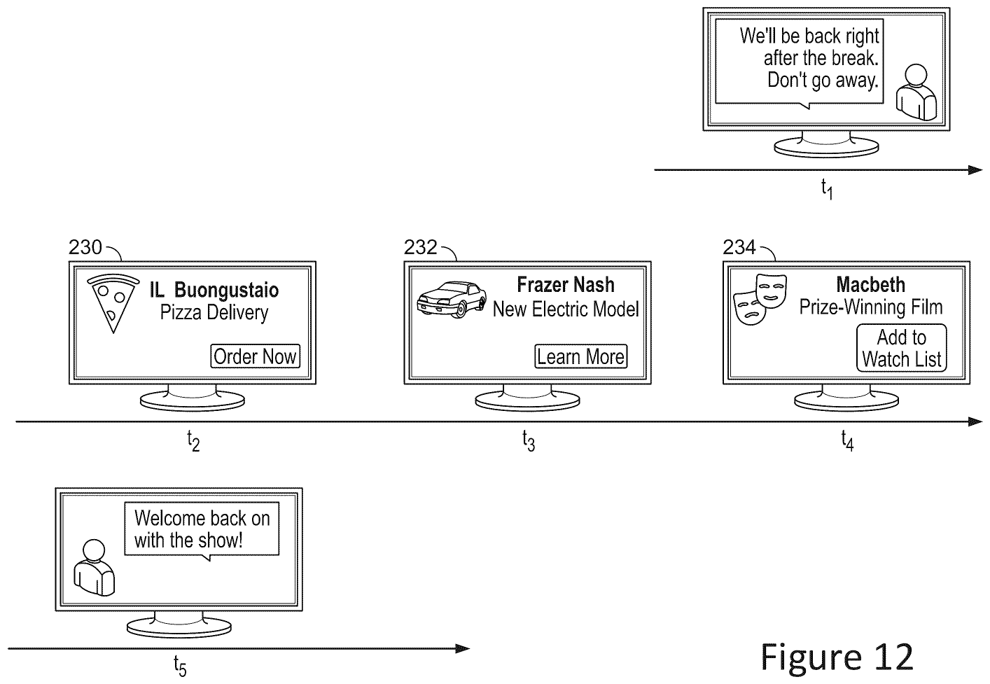

FIG. 12 illustrates an example of how the above disclosure might be used to order interactive advertisements in an advertisement break. Three interactive advertisements involving different types are interactivity are selected for inclusion in an advertisement break in live or scheduled content. A first interactive advertisement 230 is of the ‘Order Now’ type, a second interactive advertisement 232 is of the ‘Learn More’ type, and a third interactive advertisement 234 is of the ‘Add to Watch List’ type. Using, for example, a data structure like FIG. 7A, the content provision system 100 finds an interactivity type associated with each interactive advertisement (230, 232, 234), and then uses a data structure like that illustrated in FIG. 7B to determine that the interactive duration of the first interactive advertisement 230 is greater than the duration of the second interactive advertisement 232 which is in turn greater than the duration of the third interactive advertisement 234. The content provision system 100 then applies an ordering process like that illustrated in FIG. 4 to place interactive advertisements with a longer estimated duration of interaction closer to the beginning of the advertisement break. In this way, interactive advertisements are accommodated in a break of defined duration in live or scheduled content whilst reducing the likelihood of the user missing the resumption of the live or scheduled content owing to interacting with one of the interactive advertisements. This improves the utilization of the resources of the content provision system 100.

The processes described above are intended to be illustrative and not limiting. One skilled in the art would appreciate that the steps of the processes discussed herein may be omitted, modified, combined, and/or rearranged, and any additional steps may be performed without departing from the scope of the disclosure. More generally, the above disclosure is meant to be by way of example and not limiting. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

Possible variations on the above-described embodiments include (this list is by no means exhaustive):
i) whilst the above detailed description used advertisements as an example of an interactive content item, the above disclosure might instead or in addition be applied to other forms of interactive content such as games, puzzles, quizzes, polls (e.g. for audience participation in reality TV programs), forms and the like.
ii) whilst the above description described content sources including a content server, an interactive content server, and an advertiser server, in practice there may be a plurality of each type of content source, with the choice of content source being made by the user of the content consumption device, or by some other process or scheduler in the content provision system.
iii) the illustration of FIG. 12 shows a use case in which every one of the advertisements in an advertisement break is interactive. In other cases, only a subset of advertisements in an advert break might be interactive. The fixed duration of a non-interactive advertisement might then be used in an ordering process like that seen in FIG. 4.

What is claimed is:

1. A method of scheduling the display of one or more interactive content items for accommodation in a timeslot in other media content, the method comprising:
obtaining an estimated interaction duration for each of the one or more interactive content items; and
determining a display time in the timeslot for at least one of the interactive content items based on the estimated interaction duration for the at least one interactive content item.

2. The method of claim 1 further comprising displaying the at least one interactive content item on a display device in accordance with the determined display time.

3. The method of claim 1, wherein the one or more interactive content items comprise a plurality of interactive content items.

4. The method of claim 3, wherein determining the display time for at least one of the interactive content items comprises determining which of a first and second media interactive content item to be displayed in the timeslot has a longer estimated interaction duration, and assigning an earlier display time to whichever of the first and second interactive content item is determined to have a longer estimated interaction duration.

5. The method of claim 3 wherein the interactive content items comprise interactive advertisements.

6. The method of claim 5, further comprising selecting a plurality of interactive advertisements for display during the timeslot.

7. The method of claim 1, wherein obtaining estimated interaction durations for each of the one or more interactive content items comprises obtaining one or more attributes of the interactive content items, and determining the estimated interaction duration for the interactive content item based on the one or more attributes.

8. The method of claim 7, wherein the one or more attributes comprise an attribute indicative of whether the interaction requires the launching of an application on the user device.

9. The method of claim 1, wherein obtaining estimated interaction durations for the interactive content items comprises using historical interaction data for the interactive content items.

10. The method of claim 1, wherein obtaining estimated interaction durations for the interactive content items comprises using historical interaction data for the interactive content items having one or more attributes in common with the interactive content item.

11. The method of claim 1, wherein obtaining estimated interaction durations for the interactive content items comprises using historical data of a plurality of users that have interacted with the interactive content item.

12. The method of claim 1, wherein each interactive content item includes interaction duration metadata and obtaining estimated interaction durations for the interactive content items comprises reading the interaction duration metadata.

13. Content provision apparatus comprising a content scheduler arranged in operation to schedule the display of one or more interactive content items to be accommodated in a timeslot in other media content by:
obtaining an estimated interaction duration for each of the one or more interactive content items, and
determining a display time in the timeslot for at least one of the interactive content items based on the estimated interaction duration for the at least one interactive content item.

14. Content provision apparatus according to claim 13 further comprising a content player arranged in operation to display the at least one interactive content item in accordance with the determined display time.

15. A non-transitory computer-readable medium tangibly embodying instructions executable to perform the method of claim 1.
